(19) United States
(12) Patent Application Publication
(10) Pub. No.: US 2002/0077847 A1
(43) Pub. Date: Jun. 20, 2002

(54) Method for communication shipping orders for postal matter and system for the implementation of the method

(75) Inventor: Wolfgang Thiel, Berlin (DE)

Correspondence Address: SCHIFF HARDIN & WAITE, 6600 SEARS TOWER, 233 S WACKER DR, CHICAGO, IL, 60606-6473, US

(73) Assignee: Francotyp-Postalia AG & Co. KG

(21) Appl. No.: 10/022,686

(22) Filed: Dec. 17, 2001

(30) Foreign Application Priority Data
Dec. 19, 2000 (DE) 100 64 795.2

(51) Int. Cl. G06F 17/60

(52) U.S. Cl. 705/1

(57) ABSTRACT

In a method and system for communicating shipping orders for postal matter between a shipper and at least one carrier whose service are employed for conveying the postal matter to a recipient, the communication ensues via an intermediary who receives the shipping order of the shipper for at least one piece of mail. A selection of a carrier is made from a number of available carriers according to at least one predetermined selection criterion. This selection can ensue before or after receipt of the shipping order by the intermediary. The intermediary relays the shipping order to the selected carrier.

### BACKGROUND OF THE INVENTION

1. Field of the Invention

The present invention is directed to a method for communicating shipping orders for postal matter between a shipper and at least one carrier whose service are employed for conveying the postal matter to a recipient, whereby the communication ensues by means of an intermediary (agent, broker, etc.), as well as to a system for communicating shipping orders between a shipper and at least one carrier.

2. Description of the Prior Art

The future market for conveying letter mail will be characterized by state postal monopolies being gradually abandoned in the course of deregulation. New alternatives are thus made available for the customers, i.e. shippers who wish to send letter mail. In addition to the governmental authorities, private firms referred to as carriers, i.e. mail carriers, will be additionally available for the transport of letter mail and these will distinguish themselves from one another by different services and rate schedules.

In a conventional debiting system for business customers, the shipper debits the dispatch mail by means of a postage meter machine, and the postage meter machine prints a confirmation of this debiting on the letter in the form of a franking imprint. The postage meter machine has a set of registers, one of which is reduced by the franked amount (referred to as a descending register). When this register is empty, it must be replenished with monetary data. According to the state of the art, this ensues largely automatically by loading the monetary data into the postage meter machine by remote data transmission from a remote data center. This data transfer as well as the storing and bookkeeping of the data in the postage meter machine must meet the security requirements of the postal authorities.

These specified requirements are intended to prevent a manipulation of the data to the disadvantage of the postal concern. One example of current security requirements is the information based indicia program (IBIP) of the United States Postal Service (USPS), which requires the cryptographic encoding of data and printing thereof in the form of a two-dimensional bar code.

The security standards of the individual national postal authorities differ substantially. Whereas, for example, the USPS requires a public key method for the data encryption, requires the use of a secret key in the French mail system. This forces the international manufacturers of franking systems to base their products on the respective requirements of the national postal authorities, involving additional costs.

The majority of national postal authorities employ a method referred to as a prepaid method for payment for the mail service. The sum of money which the postal customer expects or wishes to employ for use of the mail service in a foreseeable time span must be available in a bank account. The mail customer requests this postage money from the data center of the postage meter machine manufacturer with his postage meter machine. This data center transfers the requested sum of money from the customer's bank account into the postage meter machine, the individual franking amounts being ultimately debited thereat. When the memory of the postage meter machine designated for storing this amount is empty, this procedure begins anew.

The necessity of always having an adequately filled bank account is disadvantageous for the customer. Another disadvantage is that the customer receives no interest for this sum of money on reserve therein.

Some postal authorities such as, for example, the French mail system, operate according to as a post-paid method. The amount for which mail was franked in a past period is thereby registered in the memory of the postage meter machine. This memory is read at specific intervals by a person authorized by the postal authority and the customer is billed accordingly.

This method means high outlay for personnel, and thus costs for the postal authority. For the manufacturer of postage meter machines, the existence of these two different payment methods means that the manufacturer must develop two different types of postage meter machine to respectively accommodate the different bookkeeping methods and must also operate to different infrastructure systems.

Further, in conventional franking systems the franking value for a specific letter or a package is calculated by the postage rate meter machine with the assistance of a postage table and on the basis of values that are input or determined. Such values can be the weight of the letter, the size and the type of shipping such as, for example, express letter, letter with return receipt, etc. The postage rate tables that calculate the respective postages from these values are stored in a specific memory of the postage meter machine.

The content of this memory must be updated when the postal authority changes its rate schedules. This usually occurs by a service technician of the manufacturer replacing the memory modules at the customer's premises. This involves considerable costs. An improved method provides for the electronic communication of the data of the new postage table. A prerequisite for this method, however, is a data line between data center of the manufacturer and postage meter machine of the postal customer. Even then, however, the problem exists that the postal customers must have the new postage table available when the new postage rate schedules take effect, which means a quasi-parallel communication of the data to a large number (perhaps 100,000) of postage meter machines.

The increasingly liberalized market for letter mail raises doubts as to the efficacy of these previous technical and logistical systems. One response to this demand is a multi-carrier compatible postage meter machine as disclosed in U.S. Pat. No. 5,699,258. With this, the postal customer has the possibility of selecting among the offerings of different, competing carriers and defining the most beneficial carrier for the customer's specific order, The outlay involved in getting the data of the offerings and in the implementation of a comparison is disadvantageous for the postal customer. Even if the postal customer is provided with corresponding programs that support both, at least the on-site outlay for apparatus will still be increased. The data for the offerings of the individual carriers must be stored on site and updated as warranted.

A further disadvantage is that the customer must settle accounts with many different carriers, which additionally increases the customer's administrative costs.

### SUMMARY OF THE INVENTION

An object of the present invention is to provide a method as well as a system that, in a simple way, enable the shipper of postal matter to organize the conveying of the shipper's postal matter according to predetermined selection criteria of different carriers with optimally little technological and administrative outlay.

This object is achieved in a method for communicating shipping orders for postal matter between a shipper and at least one carrier whose services are used for conveying the postal matter to a recipient, whereby the communication ensues by means of an intermediary. This method includes the following steps: the receipt of the shipping order of the shipper for at least one piece of mail by the intermediary, the selection of a carrier from a number of available carriers according to at least one predetermined selection criterion, whereby this selection is carried out by the intermediary before or after receipt of the shipping order, as well as the relaying of the shipping order from the intermediary to the selected carrier.

The inventive solution is based on the resignation that the administrative outlay for the shipper can be significantly reduced if the shipper itself need not communicate, for example settle accounts, with the individual, different carriers that carry out his shipping order dependent on the selection that has been made, but instead is only involved with a single contact, the intermediary, for example for accounting purposes.

The customer's technological outlay also usually is reduced since, with the inventive method, the acquisition of the aforementioned, complicated and expensive multi-carrier compatible postage meter machine is superfluous.

The selection of the carrier can be made by the shipper before or upon preparation of the shipping order insofar as the shipper has the corresponding information available for the selection. The intermediary nevertheless can contribute to reducing the outlay for the shipper in the above-described, advantageous way if the intermediary collects the appertaining information from the individual carriers and communicates the information that are relevant for the shipper.

The outlay for the shipper also is reduced because the shipper need not monitor the carrier market. The intermediary can attend to this. In particular, the intermediary can immediately provide the shipper with information, for example selection data and criteria, for new carriers who usually try to establish themselves in the marketplace with especially beneficial offers.

In a preferred embodiment of the inventive method, the selection of the carrier is made by the intermediary after receipt of the shipping order. This embodiment is based on the fact that storage of the data for the offerings of the various carriers and updating thereof as well as the determination of the respectively suitable carrier can ensue more efficiently as a centralized service. The shipper's administrative outlay for the selection of the carrier is then completely eliminated.

The selection of the carrier can ensue according to a large variety of selection criteria. Of course, various generalized aspects, as well as specific criteria can be taken into consideration and combined with one another. Thus, some of the carriers will not be able to offer area-wide delivery. Data files with those addresses to which the respective carriers deliver can be centrally administered by the carrier and queried by the interested shipper or can be taken into consideration for the shipping order.

The selection will frequently concentrate on the selection of the most beneficial carrier. Alternatively, other criteria such as speed of the conveying, delivery guarantee, insuring of the postal matter, pick-up of the postal matter, that are of interest to the shipper, can be considered additionally or in combination. Thus, for example, the carrier who picks up the postal matter at the most beneficial price and brings it to a specific destination within one day can be selected.

The shipper can undertake a specific weighting for the criteria. Particularly in the selection of the carrier, the intermediary can store this weighting, for example in a customer profile according to which the intermediary makes the selection and that the shipper preferably can modify at any time. It is also possible to indicate the weighting with every shipping order.

The debiting of the remuneration for conveying the postal matter preferably ensues between the selected carrier and the intermediary. The latter in turn invoices the shipper for the amount of the bill. The intermediary thereby preferably debits the amount of the bill from a shipper account of the shipper according to a predetermined debiting criterion.

The debiting criterion can be a time criterion. It can be agreed upon that the debiting ensues at a specific point in time, for example weekly at the start of the week. It can likewise ensue based on a volume criterion. Debiting thus can be carried out after receipt and performance of a specific number of shipping orders. These criteria can be combined with one another and can have specific precedence (hierarchy). For example, the debiting be set to ensue after a specific time span has passed but in any case after a specific quantity of postal matter has been reached, regardless of whether the predetermined time span has already passed since the last debiting.

In an embodiment, the intermediary debits the amount of the bill from a shipper account of the shipper immediately after receipt of the shipping order and selection of the carrier, in order to maintain a time-proximate overview of the costs being incurred.

In a further embodiment of the inventive method, the intermediary transfers the conveyage payment to a carrier account of the selected carrier according to a predetermined transfer criterion. There are the same possibilities for this transfer criteria as for the aforementioned debiting criterion.

Preferably, all information processes are united at an intermediary. All three participating parties—the shippers, the carriers and the intermediaries—can obtain benefit from this system: The shippers are not forced to establish various bank accounts for different carriers. As warranted, further, they need not constantly monitor the various and short-duration rate schedules of different carriers and make comparisons. Moreover, some of the carriers will not be able to offer area-wide delivery. Data files with those addresses to which the respective carriers deliver can be centrally administered by the intermediary and queried by the interested postal customers. The postal customers are only involved with one competent and independent party, the intermediary.

The carriers are not confronted with the individual debiting of letter shipments, even though their customers have this type of debiting available to them vis-a-vis the intermediary. Considerable logistical outlay is thus eliminated, particularly for new carriers entering into the letter market, and entry into the mail shipping market is facilitated.

As a bulk customer, the intermediary can purchase favorable postal services from the carriers and retain a part of this discount for rendering its service. Only the intermediary determines the procedures according to which and the technical means with which the shipper invoices him for his transport orders. The technical means can be sold or leased to the shipper. This can be a conventional “one-dimensional” postage meter machine that settles accounts with the intermediary instead of with a national postal authority. The machine alternatively can be a postage meter machine that is reset for post-paid instead of pre-paid operation. In any case, the outlay of having to provide a number of security modules in the postage meter machine, namely one for each carrier, is eliminated.

In order to obtain optimally favorable conditions from the respective carriers by the status of a bulk customer, the intermediary can acquire a specific transport capacity from the selected carrier in advance.

Alternatively, the intermediary does not purchase transport options per se from the carriers, but only transfers money after received or implemented shipping orders. The intermediary then need not advance funds, but then cannot achieve discounts to the maximum extent. A mixed form can be employed wherein the intermediary negotiates a minimum purchase of transport options.

In another version of the inventive method, the intermediary assumes responsibility for relaying the postal matter to the selected carrier in addition to the above-described tasks.

In a preferred embodiment of this version of the inventive method, only those mail shipments are transported for which the payment was also calculated. Security techniques that are already known can be used for this purpose, dependent on the expense of implementing a particular security technique in relationship to the probability of fraud.

Thus, the shipper merely can give its items to be shipped, which is not further-characterized, to the carrier or to the intermediary. An adequate trust relationship exists due to many years of delivery relations.

It can likewise be provided that the intermediary generates an identifier, for example a combination of letters and/or numerals, for each shipping order. This identifier is communicated to the appertaining carrier as well as to the shipper. At the shipper side, the corresponding postal matter is identified with this identifier. Given stacked mail, an identifier for an entire stack is generated, for example printed. When the postal matter is handed over to the intermediary or carrier, the identifier of the shipping order and the identifier of the respective postal matter are compared to one another.

In another embodiment of the inventive method, the intermediary—after receipt of the shipping order—generates an identifier pair composed of a first identifier for linking with the postal matter and a second identifier for forwarding to the carrier that have a predetermined relationship with one another. For example, the intermediary generates a pair of crypto-numbers for each shipping order and reports these both to the appertaining carrier as well as to the shipper. At the shipper side, the postal matter is identified. When the postal matter is handed over to the intermediary or carrier, the identifier of the shipping order and the identifier of the respective postal matter are compared to one another. Thus, for example, the pick-up person of the authorized carrier can have the possibility of checking the authenticity of the identifier, for example with a correspondingly programmed notebook, etc. Alternatively, this check can ensue upon receipt of the shipment in the distribution center of the carrier, for example by scanning (random sampling) the entering mail. This, of course, can ensue in the same manner upon transfer of the postal matter from the shipper to the intermediary.

Dependent on the security needs of the individual carriers, the intermediary can offer and operate different security systems. The possibility is thus available for all shippers to grant shipping orders to a multitude of carriers participating in the system without the shipper having to worry about the carriers' specific security requirements.

In another embodiment of the inventive method, the intermediary itself is the collecting and distribution center for the postal matter. The intermediary can have the postal matter picked up at the shipper by persons or services authorized by the intermediary, or the postal customer can deposit the postal matter, for example in mailboxes provided therefor.

The letter or the letter stack then contains an identification of the franking value and of the carrier. When this identification is machine-readable, for example by means of a bar code, then a third form of debiting is enabled. The letter or letter stack acquired in the collection and distribution center by means of the identifier linked to it directly triggers the debiting of the mail service for the shipper.

In one embodiment, the letter contains only a machine-readable identifier. The shipping order dataset for the letter or letter stack is identified in the shipper's data center on the basis of the acquired identifier, for example a scanned code. The advantage of this method is that the shipper is only charged for shipping fees when the shipper has actually introduced the postal matter into the shipping route. Another advantage is in that the shipper can deliver its daily mail to only a single location or can have it picked up by only a single service, even though the postal matter is to be delivered to different addressees by different carriers.

In a version of the invention the services of at least one carrier are employed for conveying the postal matter to a recipient, and communication from the shopper again ensues by means of an intermediary. The intermediary acquires a specific transport capacity from the carrier in advance. The receipt of the shipping order from the shipper for at least one postal item is then performed by the intermediary. This shipping order is then in turn relayed from the intermediary to the carrier, making use of at least a part of the pre-acquired transport capacity. In this version of the method the above-described advantages for all participants can be achieved not only in the interplay between the intermediary and a number of carriers but can also be achieved in the interplay with only one carrier.

By bundling the shipping orders of a number of shippers and the shipping volume that can thus be achieved, the intermediary can get attractive price discounts or conditions from the carrier. These can then be passed on at least in part to the shippers.

Here, as well, the debiting of the conveyage payment for the postal matter also ensues between the carrier and the intermediary, and the intermediary invoices the shipper for a billing amount.

Preferably, the intermediary debits the billing amount from an account of the shipper according to a predetermined debiting criterion, as set forth in detail above. Here, a well, the debiting of the billing amount from an account of the shipper preferably ensues after receipt of the shipping order.

In another embodiment of the inventive method, the intermediary—after receipt of the shipping order—generates an identifier pair composed of a first identifier for linking with the postal matter and a second identifier for forwarding to the carrier that have a predetermined relationship with one another, as also described in detail above. This is then forwarded to the shipper or to the carrier.

In another embodiment of the inventive method, the intermediary collects the postal matter and relays it to the carrier. The intermediary thereby can get further price reductions from the carrier, for example by pre-sorting the postal matter.

The present invention is also directed to a system for communicating shipping orders for postal matter between a shipper and at least one carrier whose services are used for conveying the postal matter to a recipient. The inventive system has at least one shipper's data processor and a central intermediary's data processor. The shipper's data processor can be connected to the intermediary's data can via a communication connection. It is also configured for sending a shipping order of the shipper for at least one postal item to the intermediary's data processor.

The intermediary's data processor and—additionally or alternatively—the shipper's data processor is configured for selecting a carrier from a number of available carriers according to at least one predetermined selection criterion, whereby this selection ensues before or upon receipt of the shipping order at the intermediary.

With this system, it is possible to implement the above-described method for communicating shipping orders for postal matter in an especially efficient way and to thus further enhance the advantages of the method that are described above.

The selection of the carrier is preferably automated at least to such an extent that the operator of the appertaining data processor is presented with a proposal for a carrier or with a list of carriers that the operator then accepts by making an input into the data processor or by selecting the desired carrier by means of a corresponding input.

The appertaining data processor is preferably also programmed such that the selection criterion can be freely prescribed by the user on the basis of an input. The user can arbitrarily combine the above-described criteria and assign weights to them. The user can be preferably assisted by the data processor in the form of additional help information. It is likewise possible for specific selection profiles with different selection criteria to be stored in the data processor, the user being then able to call these as needed.

Further, the selection is preferably automated to such an extent that the user, except for a possibly required, first-time input of the selection criterion or modification of the selection criterion, the processor requires no further inputs on the part of the user.

A carrier's data processor (of the selected carrier) can be connected to the intermediary's data processor via a communication connection. Further, the intermediary's data processor is configured for relaying the shipping order to the carrier's data processor of the selected carrier. The relaying can ensue in automated fashion, i.e. without a separate input by an operator.

For the reasons cited above in view of the simpler and more efficient concentration of the information with respect to the conditions of the individual carriers at the intermediary, the intermediary's data processor is preferably configured for selection of the carrier after receipt of the shipping order.

The intermediary's data processor can be configured for accessing a shipper account for reducing the shipper account by a billed amount. The intermediary's data processor is thereby configured for accessing the shipper account according to a predetermined deduction criterion.

In a pre-paid system, this access can ensue directly by the intermediary's data processor directly accessing an account of the shipper that is maintained at the intermediary in the form of a memory connected to the intermediary's data processor. This memory contains data representing the credit allocated to the appertaining shipper. This credit is then reduced by accessing the appertaining memory with the intermediary's data processor.

The reduction criterion can be a time criterion. It can be prescribed that the reduction ensues at a specific time, for example weekly at the start of the week. It can likewise be a quantity criterion. Thus, reduction can be carried out after receipt and implementation of a specific quantity of shipping orders. These criteria can be combined with one another with specific precedence. For example, the reduction can ensue after a specific time span has passed but, in any case, after a specific quantity of postal matter has been reached, regardless of whether the predetermined time span since the last debiting has already passed.

Preferably, the reduction ensues immediately after receipt of the shipping order and selection of the carrier in order to maintain a time-proximate overview of the costs being incurred.

It is likewise possible for the access of the intermediary's data processor to the shipper account to ensue indirectly. This occurs in an embodiment of the inventive system wherein a bank's data processor is connected to the intermediary's data processing means via a communication connection. This intermediary's data processor is again configured for preparing and communicating a debiting order for deducting a billed amount from a shipper account accessible the bank's data processor. The preparation and communication of the debiting order again ensues according to a predetermined debiting criterion as described above.

Preferably, the preparation and communication of the debiting order ensues immediately after receipt of the shipping order and selection of the carrier. In other words, the receipt of the shipping order and the selection of the carrier that then ensues are the debiting criterion.

The bank's data processor can be connected to the intermediary's data processor via a communication connection. The intermediary's data processor is configured for preparing and communicating a transfer order to the bank's data processor for transferring a conveyage payment from an intermediary account to a carrier account. The preparation and communication of the debiting order again ensues according to a predetermined transfer criterion as described above.

The intermediary's data processor is preferably configured for generating an identifier pair composed of a first identifier for linking with the postal matter and a second identifier for forwarding to the carrier after receipt of the shipping order. This first and second identifiers have a predetermined relationship to one another as described above. As a result, it is possible to efficiently utilize the advantages of the verification likewise described above of the individual postal items or mail stacks by checking the first identifier linked to them.

This has an especially fast and efficient form in a preferred embodiment of the inventive system wherein the intermediary's data processor is configured for communicating the first identifier to the shipper's data processor. The communication preferably ensues via the same communication connection that was already used for communicating the shipping order, however, a different communication connection can, of course, be used.

An increased efficiency derives in a further embodiment wherein a device is provided for linking the first identifier with the postal matter, the device being connected to the shipper's data processor. This can be a simple printer that prints the identifier on the postal matter itself or on an information carrier to be joined with the postal matter or a stack of postal matter, etc. This information carrier can either be a simple slip of paper, a simple form or, on the other hand, a stick-on label. A conventional postage meter machine alternatively can be employed for this purpose.

In another embodiment of the invention that is preferred because it is automated further, at least one carrier's data processor (of the selected carrier) can be connected to the intermediary's data processor via a communication connection. The intermediary's data processor is also configured for the communication of the second identifier to the shipper's data processor.

A check device is then preferably provided, this being connected to the carrier's data processor and being configured for reading and comparing the first identifier joined to the postal matter with the second identifier in order to thus enable an optimally automated mail processing.

### DESCRIPTION OF THE DRAWINGS

FIG. 1 is a block diagram of an inventive system for the implementation of the inventive method for communicating shipping order for postal matter.

FIG. 2 is a flowchart of a preferred version of the inventive method that can be implemented with the system according to FIG. 1.

FIG. 3 is a block diagram of a further inventive system for the implementation of the inventive method for communicating shipping orders for postal matter.

FIG. 4 is a flowchart of another preferred version of an inventive method that can be implemented with the system according to FIG. 3.

### DESCRIPTION OF THE PREFERRED EMBODIMENTS

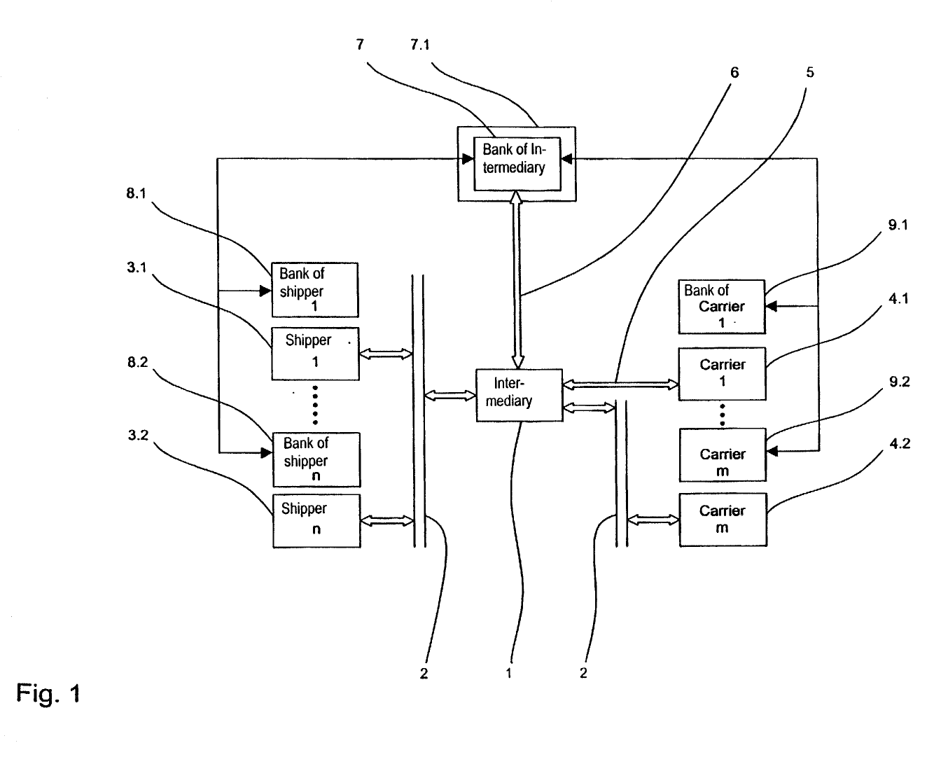

A preferred exemplary embodiment of the invention solution shall be explained on the basis of FIG. 1.

The intermediary operates an intermediary's data processor in the form of a data center 1. This data center 1 is in communication with respective shippers' data processors of n different shippers via a data network 2 as well as with respective carriers' data processor of m different carriers. For clarity, FIG. 1 only shows the shipper's data processor 3.1 of the shipper 1 and the shipper's data processor 3.2 of the shipper n as well as the carrier's data processor 4.1 of the carrier 1 and the carrier's data processor 4.2 of the carrier m.

The shippers' data processor 3.1 and 3.2 are PC franking devices. A data network such as the Internet is utilized as suitable data network for the data connection of the data center 1 to the shippers' data processor 3.1 and 3.2, whereby the shippers' data processor 3.1 and 3.2 are coupled to the data network via modem or some other known data conversion means.

It is self-evident, however, that each shipper's data processor can be implemented as a classic postage meter machine in other versions of the invention. The connection to the data center of the intermediary can then be produced by means of a telephone network via the modem usually allocated to the postage meter machine and a protocol implemented by the manufacturer.

The data network 2, for example the Internet, likewise is connected to the carrier's data processor 4.2. A dedicated data line 5 is provided for the connection to the carrier's data processor 4.1 of a carrier that is used especially often.

In other version, however, only such data networks or only such dedicated data lines are employed for the connections between the center of the intermediary and the carriers' data processor or between the center of the intermediary shippers' data processor.

The data center 1 is also connected via a dedicated data line 6 to a bank's data processor 7 of the contractual bank 7.1 of the intermediary. It is self-evident that, however, a large variety of other data connections can be utilized.

The shippers maintain an account at their respective contractual banks 8.1 and 8.2 from which billed amounts of the intermediary can be deducted. To this end, they have granted the intermediary corresponding collection authorizations that the intermediary has in turn forwarded to its contractual bank 7.1. This version assures a fast money transfer for the intermediary and is low-outlay for the shipper.

Upon instruction of the data center 1 that is communicated to the bank's data processor 7 of the contractual bank 7.1, an amount for the mail service of a carrier is transferred to the contractual bank 9.1 of a carrier. In the present exemplary embodiment, this amount corresponds to the sum of the conveyage payments for the postal matter of those shippers that were shipped during the accounting period making use of the service of this carrier. Correspondingly, sums of money are likewise calculated and transferred to the other carriers, these sums corresponding to the overall use of their services.

In the simplest case, the accounting period to be declared for the shipper, i.e. the debiting criterion, is identical with the accounting period for the carrier, i.e. the transfer criterion. It is more efficient, however, to provide a longer accounting period, for example a week, for the respective shipper and a shorter one, for example one day, for the respective carrier since relevant sums of money are already to be transferred to the carrier in one day due to the accumulation over a number of shippers.

Of course, the accounting period for individual shippers can be differently defined dependent on their average mail volume. This is likewise possible at the carriers. The important factor is that the shipper as well as the carrier are relieved of accounting outlay due to the concentrating of the individual invoices by the intermediary's data center 1.

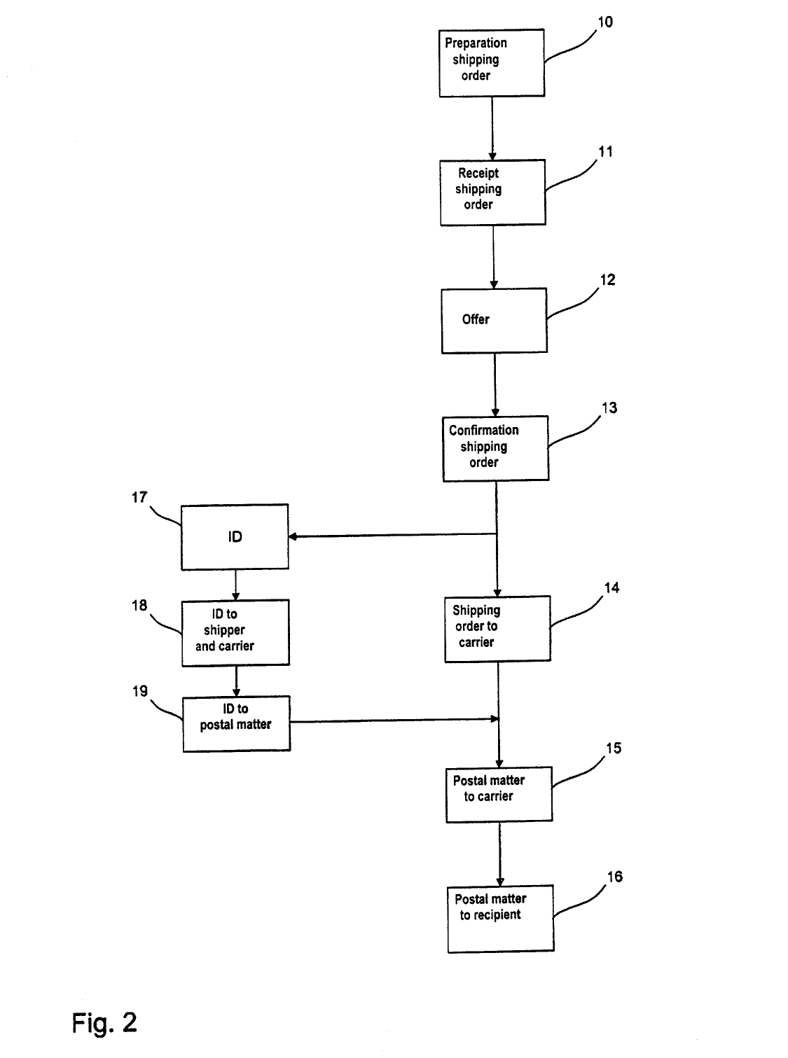

Mailing by a shipper with the system described in FIG. 1 proceeds as shown in FIG. 2.

It is assumed that the shipper would like to send an advertizing mailing to specific customers in a specific distribution area. The respective pieces of mail thereby have a specific size and weight. With the shipper's data processor 3.1, the shipper prepares a shipping order in step 10 that contains the parameters of number, format, weight, region, etc., as well as the selection criterion “most economic shipping”.

For facilitating the evaluation, the intermediary develops request forms with which the intermediary prescribes parameters that are relevant for the preparation of the shipping order. This form can be fetched via the intermediary's home page and displayed to the shipper on the shipper's data processor 3.1. The shipper then fills out the corresponding fields with the parameters of his planned mailing action and thus prepares the shipping order.

In step 11, this shipping order is then sent with the shipper's data processor 3.1 via the data network 2 to the data center 1 of the intermediary.

In step 12, the data center 1 of the intermediary uses the data supplied by the shipper to determine the most beneficial carrier for this shipping order and makes a corresponding offer to th shipper, this being sent from the data center 1 via the data network 2 to the shipper's data processor 3.1. When the shipper concurs, the shipper can—in the simplest case—validate the shipping order by confirmation in step 13 by confirmation in a corresponding field of the request form and retransmission.

It is self-evident, however, that in other versions of the inventive method the shipper need not longer receive an offer that the shipper would have to confirm, instead that the intermediary already selects the most beneficial carrier upon initial receipt and implements the order.

In order to identify the most beneficial carrier, the data center 1 has the current mail services and appertaining postage tables of the various carriers available to it. When the structure of the mail services or the rate schedules change, the carriers report these changes to the data center 1 of the intermediary with the carriers' data processor 9.1 and 9.2. Limited time rate schedules (special offers) are also stored in the data center 1 and forwarded to the shippers given a corresponding request. The most beneficial method of making revised rate schedules of the carrier available is for the carrier to transmit suitably formatted datasets to the data center 1. These can be provided with a data after which the new postage tables are valid.

When the shipper has granted and confirmed the shipping order, this, together with the shipper's address, is forwarded in step 14 from the data center 1 of the intermediary to the carrier's data processor 9.1 of the carrier selected in the example. The shipping order is registered thereat and the implementation is started.

As a rule, a courier is sent to the shipper, and the courier picks up the shipper's postal matter in step 15 and supplying it to the carrier's internal distribution center. The pieces of mail are sorted thereat according to the destination region and are ultimately delivered to the addressees in step 16. When a pre-sorting on the part of the shipper occurs, this can be rewarded by a discount.

In the illustrated case, the service of the intermediary is paid for in the following way. The individual postage values in the postage table that are stored in the data center 1 for each carrier contain a corresponding percentage surcharge, for example 1% of the postage value, that the intermediary does not forward to the carrier but keeps. A discounting according to the scope of the shipping order is possible on the basis of graduated percentages. Another way to accomplish this is to additionally bill the postal customer for the intermediary's services in a debit note method.

In the above embodiment of the inventive solution, an agreement is made between the shipper and a carrier, whereby the intermediary informs and mediates.

In an alternative version, the shipper authorizes the intermediary to carry out the shipping. The intermediary has contractually committed various carriers to perform. The difference compared to the above exemplary embodiment is that, at the request of the shipper, the intermediary does not select and deliver a carrier's offer but makes an offer in his own name. This means that, for marketing reasons, the intermediary can make an offer to the postal customer that is independent of the conditions of the executing carrier. For example, in order to acquire a new customer, this offer can be below the costs of the executing carrier.

In this way as well, the intermediary has the possibility of negotiating discounts with the carriers that are based on the order volume that the intermediary grants to the respective carrier and not on the order volume that individual shippers grant to the carrier. Since the order volume given by the intermediary is usually greater than that of the individual shippers, the amount of the discount to be negotiated is greater. Of this discount amount, a part can again be passed on to the shippers. A separate invoicing of the intermediary's service is eliminated.

It must be assured that only those items of mail for which the postal customer has placed an order, and consequently for which the customer is billed are transported by the carrier. The postal customer' must be prevented from obtaining a financial advantage by delivering more items of mail or ones different from the declared items of mail to the carrier. Third parties who identify themselves as apparently true postal customers with falsified credentials must also be prevented from mailing postal matter.

A security system that is easy to manage and that prevents the above manipulations is described below.

In step 17 after a shipping order has been received and confirmed, the intermediary generates a pair of first and second identifiers in the form of a pair of two numbers with the assistance of the data center 1 for this purpose, these two numbers being identical or having a predetermined mathematical relationship to one another. For enhancing the security, the numbers can have so many places that they do not repeat. Given, for example, a ten-place number, 9,999,999,999 different identifiers are possible, with which all shipping orders can be distinguishable from one another for the foreseeable future.

In step 18, the first identifier, i.e. the first number, is transmitted by the data center 1 via the data network 2 to the shipper's data processor 3.1 of the shipper placing the order; the second identifier, i.e. the second number, is transmitted from the data center 1 via the data line 5 to the carrier's data processor 9.1 of the selected carrier. This transmission can be encrypted in order to enhance the security, for example by using a known encryption program.

In step 19, the shipper identifies the shipper's postal matter with this number. In order to make this number machine-readable, the identification preferably ensues with a bar code that represents the number. Given letters, the simplest way of imprinting this identifier ensues in the address field of the letter that can be read through the window of a window envelope. An alternative method is imprinting the identifier on the envelope. A label can be glued on the envelope or the printer device of a postage meter machine can be utilized.

The second number transmitted to the carrier allows the carrier to allocate the postal matter to the shipping order by comparison to the identifier on the collected postal matter. For example, this comparison can ensue automated fashion in the mail distribution center of the carrier by scanning the incoming pieces of mail. Alternatively, the carrier can make the identification when picking up the postal matter from the shipper by means of the person making the pick-up having a scanner in which the outstanding numbers are stored or that allows a connection to be set up to the carrier's data processor 9.1 or to the data center of the intermediary, where the comparison is then performed.

An alternative method for preventing fraudulent manipulations is to provide the postal matter with information that allow a determination of the value for the shipping of this postal matter. The information are date, sender, size, weight, destination address or others. This information can be generated from the shipping order by appropriate programs installed at the shipper's premises. Additionally, a digital signature can be generated in this way using a key, this digital signature serving for the authentification of the information. The data then can be printed on the postal matter in fundamentally the same way as described above. These data are read at the carrier side and the digital signature is verified with an appertaining key. The generation and administration of the key is implemented by the intermediary's data center 1.

In another version, the intermediary is the collection and distribution center for the postal matter. The intermediary can have the postal matter picked up at the shipper by persons or services authorized by the intermediary or the postal customer drops off the postal matter, for example in mailboxes provided therefor.

The letter or the letter stack contains an identification of the franking value and of the carrier. When this identification is machine-readable, for example by means of a bar code, a third form of debiting is also enabled. Due to the identifier linked to it, the letter or letter stack acquired in the collection and distribution center directly triggers the debiting of the mail service for the shipper.

The letter may contain only a machine-readable identifier. The shipping order dataset for the letter or letter stack is identified in the data center of the shipper on the basis of the acquired identifier, for example a scanned code. The advantage of this method is that the shipper is only charged with shipping fees if the shipper actually placed the postal matter into the shipping pipeline. Another advantage is the shipper can deliver its daily mail to only one location or have it picked up by only one service even though the postal matter is to be delivered to the addressees by different carriers.

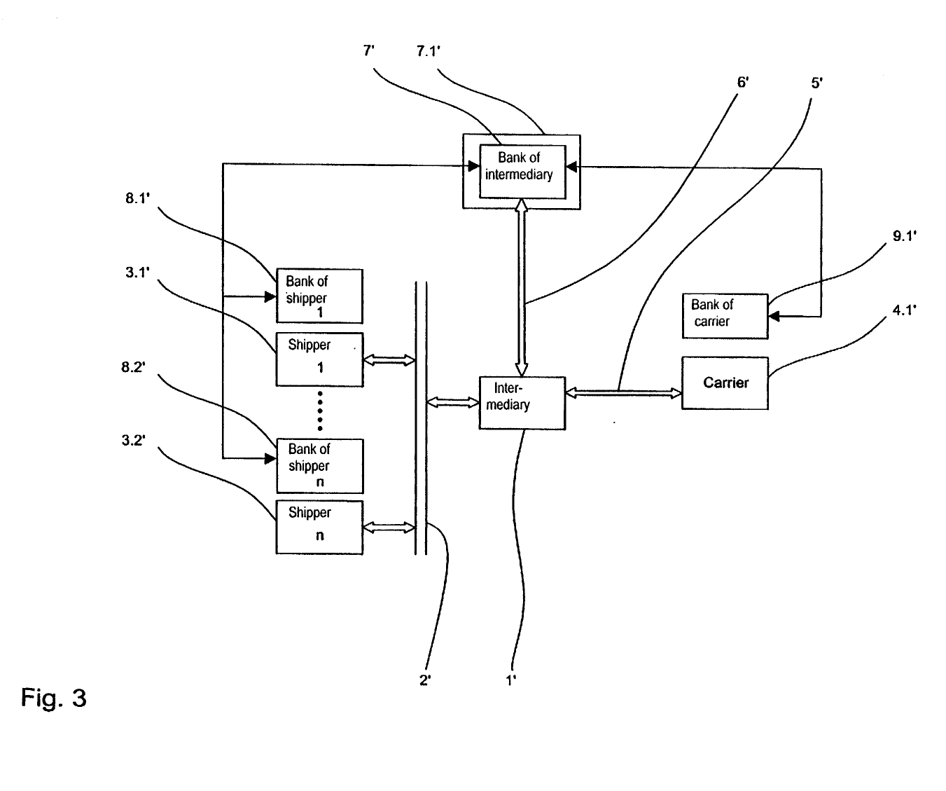

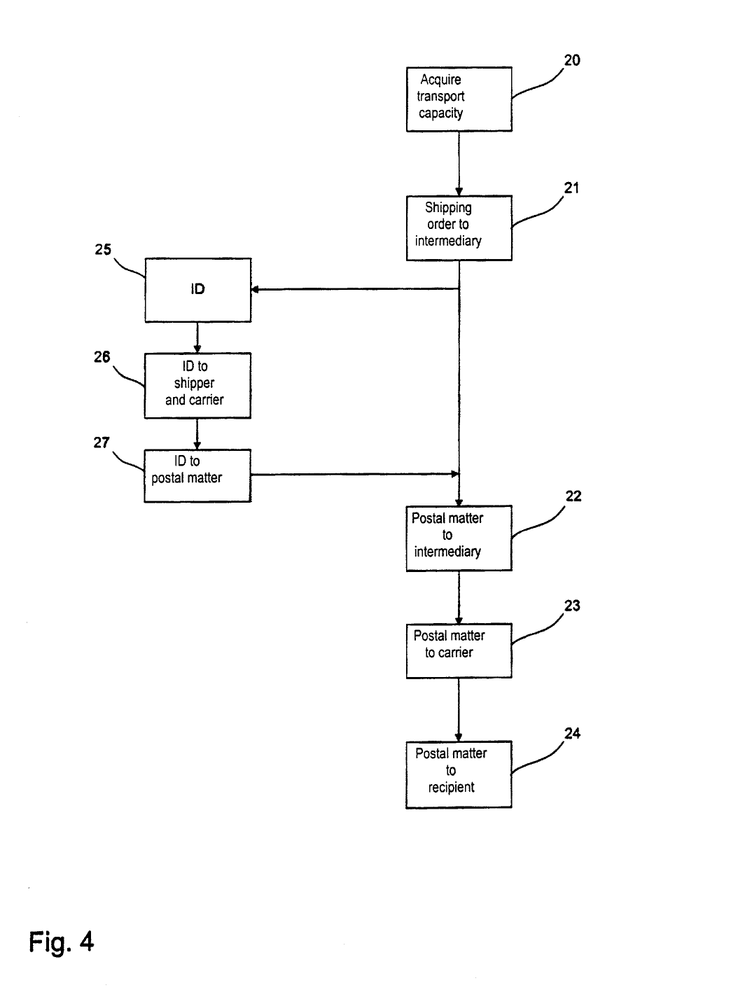

FIG. 4 shows a flowchart of a version of a further version of the inventive method wherein the intermediary collaborates with only a single carrier. This method can be implemented with a system according to FIG. 3 that is identical to the system described in FIG. 1 except for the difference that only a single carrier is provided.

In step 20, the intermediary acquires a specific transport capacity in advance from the carrier at correspondingly favorable conditions of a bulk user. These favorable conditions can be based on the high order volume or on further service that the intermediary provides, for example sorting or at least pre-sorting of the postal matter.

It is assumed that the shipper would like to send one or more shipments to one or more recipients. The respective postal items have a specific size and weight. With the assistance of the shipper's data processor 3.1′, the shipper prepares a shipping order that contains the parameters of number, format, weight, region, etc.

For facilitating the evaluation, the intermediary has developed request forms with which the intermediary prescribes parameters that are relevant for the preparation of the shipping order. This form can be fetched via the intermediary's home page and displayed to the shipper on the shipper's data processor3.1′. The shipper then fills out the corresponding fields with the parameters of the shipper's planned mailing and thus prepares the shipping order.

In step 21, this shipping order is then sent with the shipper's data processor 3.1′ via the data network 2 to the data center 1 of the intermediary.

The shipper authorizes the intermediary to ship the postal matter with the shipping order. For marketing reasons, the intermediary can make an offer to the shipper that is independent of the conditions of the executing carrier. For example, in order to acquire a new customer, this can be below the costs of the carrier.

When the shipper has placed the shipping order, the execution thereof is started. As a rule, the intermediary sends a courier to the shipper who picks up the shipper's postal matter in step 22 and delivers it to the intermediary's internal distribution center. At that location, the postal matter is sorted or pre-sorted according to the destination region or according to other criteria in order to satisfy the conditions under which the transport capacity was acquired from the carrier. In step 23, the postal matter is handed over to the carrier, who finally delivers it to the addressee in step 24. If a presorting has already been carried out by the shipper, then the carrier can remunerate this with a discount.

In this way, the intermediary has the possibility of negotiating discounts with the carrier that are based on the order volume that the intermediary gives to the carrier on the basis of the advance acquisition of the transport capacities and not on the order volume that individual shippers give to the carrier. The amount of the discount to be negotiated is greater since the order volume given by the intermediary is greater than that of the individual shippers. A part of this discount amount can in turn be passed on to the shippers.

In a version of the method only a part of the mail volume forwarded to the carrier from the intermediary may be covered by the transport capacities acquired in advance, and the remaining part may still be separately invoiced between the intermediary and the carrier. As warranted, this can occur under variable conditions.

It must be assured that only those items of mail for which the postal customer has placed an order and, consequently, for which the customer is billed are transported by the carrier. The postal customer must be prevented from delivering more items of mail or ones different from the declared items of mail to the intermediary and the carrier in order to obtain an unfair financial advantage. Third parties who identify themselves as apparently true postal customers with falsified particulars must also be prevented from mailing postal matter.

A security system that is easy to manage and that prevents the above manipulations is described below.

In step 25 after a shipping order has been received and confirmed, the intermediary generates a pair of first and second identifiers in the form of a pair of two numbers with the assistance of the data center 1′ for this purpose, said two numbers being identical or having a predetermined mathematical relationship to one another. For enhancing the security, the numbers can have so many places that they do not repeat. Given, for example, a ten-place number, 9,999,999,999 different identifiers are possible, with which all shipping orders can be identified distinguishable from one another for the foreseeable future.

In step 26, the first identifier, i.e. the first number, is transmitted by the data center 1′ via the data network 2′ to the shipper's data processor 3.1′ of the shipper placing the order; the second identifier, i.e. the second number, is transmitted from the data center 1′ via the data line 5′ to the carrier's data processor 9.1′ of the carrier. This transmission can ensue encrypted in order to enhance the security, for example by applying a known encryption program.

In step 27, the shipper identifies his postal matter with this number. In order to make this number machine-readable, the identification preferably ensues with a bar code that represents the number. Given letters, the simplest way of imprinting this identifier ensues in the address field of the letter that can be read through the window of a window envelope. An alternative method is imprinting the identifier on the envelope. A label can be glued on the envelope or the printer device of a postage meter machine can be utilized.

The second number transmitted to the carrier allows the carrier to allocate the postal matter to the shipping order by comparison to the identifier on the collected postal matter. For example, this comparison can ensue automated fashion in the mail distribution center of the carrier by scanning the incoming pieces of mail. Alternatively, the identification can be made when handing over the postal matter from to the intermediary by providing the person making the pick-up with a scanner in which the outstanding numbers are stored or that allows a connection to be set up to the intermediary's data center 1′, or to the carrier's data processor 9.1 as well, where the comparison is then performed.

An alternative for preventing fraudulent manipulations is to provide the postal matter with information that allows a determination of the value for the shipping of this postal matter. Such information can be date, sender, size, weight, destination address or other features. The information can be generated from the shipping order by appropriate programs installed at the shipper's premises. Additionally, a digital signature can be generated in this way with the assistance of a key, this digital signature serving for the authentification of the information. The data can then be printed on the postal matter in fundamentally the same way as described above. These information are read at the carrier side and the digital signature is verified with an appertaining key. The generation and administration of the key is implemented by the intermediary's data center 1.

In another version, the shipper himself delivers the postal matter, for example in mailboxes provided therefor.

The accounting between intermediary and shipper ensues analogous to the way described with reference to FIG. 1.

The shippers maintain an account at their respective contractual banks 8.1′ or 8.2′ from which billed amounts of the intermediary can be deducted. To this end, they have granted the intermediary corresponding collection authorizations that the latter in turn forwarded to his contractual bank 7.1′. This version assures a fast money transfer for the intermediary and is low-outlay for the shipper.

Upon instruction of the data center 1′ that is communicated to the bank's data processor 7′ of the contractual bank 7.1′, an amount for transport capacities is transferred to the contractual bank 9.1′ of the carrier for advance acquisition of transport capacities.

A specific accounting period, i.e. a specific debiting criterion, has been declared for the shipper. This can be configured in the way already presented in detail above. Thus, for example, weekly accounting is possible.

Of course, the accounting period for individual shippers can be differently defined dependent on their average mail volume. The important feature is that the shipper as well as the carrier are relieved of accounting outlay due to the concentration of the individual invoices by the intermediary's data center 1′. The carrier is unburdened further by the advance acquisition of the transport capacities.

In versions of the invention, the letter or the letter stack contains an identification of the franking value and of the carrier. If this identification is machine-readable, for example by means of a bar code, another form of debiting is also enabled. Due to the identifier linked to it, the letter or letter stack acquired in the collection and distribution center thereby directly triggers the debiting of the mail service for the shipper.

In a version as well, the letter may contain only a machine-readable identifier. The shipping order dataset for the letter or letter stack is identified in the data center of the intermediary on the basis of the acquired identifier, for example a scanned code. The advantage of this method is that the shipper is only charged with shipping fees when he actually placed the postal matter into the shipping pipeline.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for communicating shipping orders for postal matter between a shipper and at least one carrier, comprising the steps of:
receiving a shipping order, at an intermediary, from a shipper for at least one postal item;
selecting a carrier from among a plurality of available carriers according to at least one predetermined selection criterion, at a time selected from the group consisting of a time before receipt of said shipping order by said intermediary and a time after receipt of said shipping order by said intermediary; and
relaying said shipping order from said intermediary to the selected carrier.

2. A method as claimed in claim 1 comprising selecting said carrier at said intermediary after receipt of said shipping order.

3. A method as claimed in claim 1 wherein shipping of said postal item has a conveyage remuneration associated therewith, and comprising the step of said selected carrier charging said intermediary for said conveyage remuneration, and said intermediary sending an invoice to said shipper for an invoice amount dependent on said conveyage remuneration.

4. A method as claimed in claim 3 comprising maintaining a shipper account of said shipper accessible by said intermediary, and deducting said invoice amount from said shipper account according to a predetermined debiting criterion.

5. A method as claimed in claim 4 wherein said intermediary deducts said invoice amount from said shipper account after receipt of said shipping order and selection of said carrier.

6. A method as claimed in claim 3 comprising the step of transferring said conveyage remuneration from said intermediary to a carrier account for said selected carrier according to a predetermined transfer criterion.

7. A method as claimed in claim 3 comprising acquiring, at said intermediary, a specified transport capacity from said carrier at least in advance of relaying said shipping order from said intermediary to said selected carrier.

8. A method as claimed in claim 1 comprising, after receipt of said shipping order at said intermediary, generating an identifier pair at said intermediary composed of a first identifier for linking with said postal item and a second identifier, said first and second identifiers having a predetermined relationship with each other, and forwarding said second identifier from said intermediary to said selected carrier.

9. A method for forwarding postal matter in a route from a shipper to a recipient, comprising the steps of:
at an intermediary, receiving a shipping order from said shipper for at least one postal item;
selecting a carrier for said postal item from among a plurality of available carrier according to at least one predetermined selection criterion, at a time selected from the group consisting of a time before receipt of said shipping order by said intermediary and a time after receipt of said shipping order by said intermediary;
delivering said postal item to said shipper to said intermediary;
relaying said shipping order from said intermediary to said selected carrier; and
relaying said postal item from said intermediary to said selected carrier.

10. A method as claimed in claim 9 comprising selecting said carrier at said intermediary after receipt of said shipping order.

11. A method as claimed in claim 9 wherein shipping of said postal item has a conveyage remuneration associated therewith, and comprising the step of said selected carrier charging said intermediary for said conveyage remuneration, and said intermediary sending an invoice to said shipper for an invoice amount dependent on said conveyage remuneration.

12. A method as claimed in claim 11 comprising maintaining a shipper account of said shipper accessible by said intermediary, and deducting said invoice amount from said shipper account according to a predetermined debiting criterion.

13. A method as claimed in claim 12 wherein said intermediary deducts said invoice amount from said shipper account after receipt of said shipping order and selection of said carrier.

14. A method as claimed in claim 11 comprising the step of transferring said conveyage remuneration from said intermediary to a carrier account for said selected carrier according to a predetermined transfer criterion.

15. A method as claimed in claim 11 comprising acquiring, at said intermediary, a specified transport capacity from said carrier at least in advance of relaying said shipping order from said intermediary to said selected carrier.

16. A method as claimed in claim 9 comprising, after receipt of said shipping order at said intermediary, generating an identifier pair at said intermediary composed of a first identifier for linking with said postal item and a second identifier, said first and second identifiers having a predetermined relationship with each other, and forwarding said second identifier from said intermediary to said selected carrier.

17. A method as claimed in claim 16 comprising forwarding said first identifier from said intermediary to said shipper for linking with said postal item.

18. A method for conveying postal matter from a shipper to a recipient comprising the steps of:
preparing a shipping order at a shipper for at least one postal item;
forwarding said shipping order from said shipper to an intermediary;
selecting a carrier for said postal item from among a plurality of available carriers according to at least one predetermined selection criterion, at a time selected from the group consisting of a time before receipt of said shipping order by said intermediary and a time after receipt of said shipping order by said intermediary;
relaying said shipping order from said intermediary to the selected carrier;
relaying the postal item to the selected carrier; and
conveying the postal item from the selected carrier to the recipient.

19. A method as claimed in claim 18 comprising selecting said carrier at said intermediary after receipt of said shipping order.

20. A method as claimed in claim 18 wherein shipping of said postal item has a conveyage remuneration associated therewith, and comprising the step of said selected carrier charging said intermediary for said conveyage remuneration, and said intermediary sending an invoice to said shipper for an invoice amount dependent on said conveyage remuneration.

21. A method as claimed in claim 20 comprising maintaining a shipper account of said shipper accessible by said intermediary, and deducting said invoice amount from said shipper account according to a predetermined debiting criterion.

22. A method as claimed in claim 21 wherein said intermediary deducts said invoice amount from said shipper account after receipt of said shipping order and selection of said carrier.

23. A method as claimed in claim 20 comprising the step of transferring said conveyage remuneration from said intermediary to a carrier account for said selected carrier according to a predetermined transfer criterion.

24. A method as claimed in claim 18 comprising acquiring, at said intermediary, a specified transport capacity from said carrier at least in advance of relaying said shipping order from said intermediary to said selected carrier.

25. A method as claimed in claim 18 comprising, after receipt of said shipping order at said intermediary, generating an identifier pair at said intermediary composed of a first identifier for linking with said postal item and a second identifier, said first and second identifiers having a predetermined relationship with each other, and forwarding said second identifier from said intermediary to said selected carrier.

26. A method as claimed in claim 25 comprising forwarding said first identifier from said intermediary to said shipper for linking with said postal item.

27. A method for communicating a shipping order for postal matter between a shipper and at least one carrier, comprising the steps of:
at an intermediary, acquiring a specific transport capacity from a carrier;
receiving a shipping order from a shipper for at least one postal item at said intermediary; and
relaying said shipping order from said intermediary to said carrier and thereby making a reduction to said specific transport capacity.

28. A method as claimed in claim 27 wherein shipping of said postal item has a conveyage remuneration associated therewith, and comprising the step of said selected carrier charging said intermediary for said conveyage remuneration, and said intermediary sending an invoice to said shipper for an invoice amount dependent on said conveyage remuneration.

29. A method as claimed in claim 28 comprising maintaining a shipper account of said shipper accessible by said intermediary, and deducting said invoice amount from said shipper account according to a predetermined debiting criterion.

30. A method as claimed in claim 29 wherein said intermediary deducts said invoice amount from said shipper account after receipt of said shipping order and selection of said carrier.

31. A method as claimed in claim 27 comprising, after receipt of said shipping order at said intermediary, generating an identifier pair at said intermediary composed of a first identifier for linking with said postal item and a second identifier, said first and second identifiers having a predetermined relationship with each other, and forwarding said second identifier from said intermediary to said selected carrier.

32. A method as claimed in claim 27 comprising receiving said postal item at said intermediary and forwarding said postal item from said intermediary to said carrier.

33. A system for communicating shipping orders for postal matter between a shipper and at least one carrier, comprising:
a shipper's data processor located at a shipper;
an intermediary's data processor located at an intermediary;
a communication link for establishing at least a temporary communication connection between said shipper's data processor and said intermediary's data processor;
said shipper's data processor being programmed for sending a shipping order from said shipper via said communication connection for at least one postal item to said intermediary's data processor; and
at least one of said intermediary's data processor and said shipper's data processor being programmed for selecting a carrier for said postal item from among a plurality of available carriers according to at least one predetermined selection criterion, at a time selected from the group consisting of a time before receipt of said shipping order by said intermediary and a time after receipt of said shipping order by said intermediary.

34. A system as claimed in claim 33 further comprising a carrier's data processor at said selected carrier, a further communication link for establishing at least a temporary further communication link between said intermediary's data processor and said carrier's data processor, and wherein said intermediary's data processor is programmed for forwarding said shipping order via said further communication link from said intermediary's data processor to said carrier's data processor.

35. A system as claimed in claim 33 wherein said intermediary's data processor is programmed to select said carrier from among said plurality of available carriers after receiving said shipping order.

36. A system as claimed in claim 33 wherein conveying of said postal item by said carrier to a recipient has a conveyage remuneration associated therewith, and wherein said intermediary's data processor is programmed to access a shipper account to reduce said shipper account by an invoice amount dependent on said conveyage remuneration, according to a predetermined account reduction criterion.

37. A system as claimed in claim 33 further comprising a bank's data processor located at a bank at which said shipper has a shipper account, and further comprising a further communication link for establishing at least a temporary further communication connection between said intermediary's data processor and said bank's data processor, and wherein said intermediary's data processor is programmed to prepare and forward a debiting order, via said further communication link, to said bank's data processor for causing said bank's data processor to deduct an invoice amount from said shipper account, according to a predetermined debiting criterion.

38. A system as claimed in claim 37 wherein said intermediary's data processor is programmed to employ receipt of said shipping order and selection of said carrier as said predetermined debiting criterion.

39. A system as claimed in claim 33 further comprising a bank's data processor located at a bank at which said carrier has a carrier account, and a further communication link for establishing at least a temporary further communication connection between said intermediary's data processor and said bank's data processor, and wherein said intermediary's data processor is programmed for preparing and forwarding a transfer order via said further communication link to said bank's data processor for transferring a conveyage remuneration, for conveying said postal item, from an intermediary account to said carrier account, according to a predetermined transfer criterion.

40. A system as claimed in claim 33 wherein said intermediary's data processor is programmed to generate an identifier pair composed of a first identifier for linking with said postal item and a second identifier, said first and second identifiers having a predetermined relationship to each other, and for forwarding said second identifier to said carrier after receipt of said shipping order.

41. A system as claimed in claim 40 wherein said intermediary's data processor is programmed to communicate said first identifier to said shipper's data processor via said communication link.

42. A system as claimed in claim 41 further comprising a device connected to said shipper's data processor for linking said first identifier with said postal matter after receipt of said first identifier from said intermediary's data processor.

43. A system as claimed in claim 40 further comprising a carrier's data processor located at said carrier, and a further communication link for establishing at least a temporary further communication connection between said intermediary's data processor and said carrier's data processor, and wherein said intermediary's data processor is programmed to transmit said second identifier, via said further communication connection, to said carrier's data processor.

44. A system as claimed in claim 43 further comprising a checking device connected to said carrier's data processor for reading said first identifier linked with said postal item and for comparing said first identifier to said second identifier.
